(19) United States
(12) Patent Application Publication
(10) Pub. No.: US 2012/0284333 A1
(43) Pub. Date: Nov. 8, 2012

(54) COLLECTION AND ANALYSIS OF LOCATION DATA FROM LOCATION-AWARE MOBILE DEVICES ON A NETWORK

(76) Inventor: Ryan A. Neff, Lincoln Park, NJ (US)

(21) Appl. No.: 13/402,903

(22) Filed: Feb. 23, 2012

Related U.S. Application Data
(60) Provisional application No. 61/445,561, filed on Feb. 23, 2011.

(51) Int. Cl. G06F 15/16

(52) U.S. Cl. 709/204

(57) ABSTRACT

A method according to an embodiment of the invention can include using a computer in a) receiving data from first devices associated with users of a social networking service, where the data represent respective geographic locations of the users; b) storing location information representative of respective geographic locations of the users; c) storing information representing an event and a geographic location of the event; and d) transmitting information to at least one second device, the transmitted information including a result of retrieving the stored location information of users whose geographic locations match the geographic location of the event, together with the geographic location of the at least one event, and a quantity of the users whose geographic locations match the geographic location of the at least one event.

### CROSS-REFERENCE TO RELATED APPLICATION

This application claims the benefit of the filing date of U.S. Provisional Application 61/445,561 filed Feb. 23, 2011, the disclosure of which is incorporated by reference herein.

### BACKGROUND OF THE INVENTION

1. Field of the Invention

This invention relates to a method, system and related program product for providing information related to a variety of components to one or more nodes and processors across the system.

2. Description of Related Art

Online social networking services, particularly websites (“sites”) today employ a variety of methods to collect user data and present it back to them in an intuitive, useful manner. Furthermore, the value of social networking sites, where a user can connect with others across the Internet and share information with his or her peers, is not only limited in its ability to distribute information effectively with a large audience but also to analyze this data and present users with information that he or she is particularly interested in. Sometimes, this data can be in the form of messages, pictures, video, third-party applications, and location data from mobile devices.

Further improvements can be made in the provision of social networking services.

### SUMMARY OF THE INVENTION

An aspect of the invention provides a method which comprises using at least one computer in: a) receiving data from first devices associated with users of a social networking service, the data representing respective geographic locations of the users; b) storing location information representative of respective geographic locations of the users, and storing information representing an event and a geographic location of the event; c) storing information representing an event and a geographic location of the event; and d) transmitting information to at least one second device, the transmitted information including a result of retrieving the location information of users whose geographic locations match the geographic location of the event, together with the geographic location of the at least one event, and a quantity of the users whose geographic locations match the geographic location of the at least one event.

In accordance with an aspect of the invention, data can be received from first devices associated with respective users of a social networking service, in which the data may include data representing respective geographic locations of the users. Location information representative of respective geographic locations of the users can be stored using the received data, for example, information can be stored which represents an event and a geographic location of the event. Information can be transmitted to at least one second device, in which the transmitted information may include a result of retrieving the location information of users whose geographic locations match the geographic location of the event. Such transmitted information can be transmitted together with the geographic location of the at least one event. The transmitted information can also include information representative of a quantity of the users whose geographic locations match the geographic location of the at least one event.

In accordance with a particular aspect of the invention, the information including the result which is transmitted can represent a plurality of the events, the respective geographic locations thereof, and the respective quantities of users whose geographic locations match the geographic locations of the events.

In accordance with a particular aspect of the invention, the method may further include, prior to transmitting the information including the result, sorting the result according to the respective quantities of the users. In accordance with a particular aspect of the invention, the quantity represented by the result can represent a count of the users. In accordance with a particular aspect of the invention, the quantity represented by the result can include a relative statement of the number of users. In accordance with a particular aspect of the invention, the quantity represented by the result may include a statement of a quantitative range of the number of users.

The method can be performed such that the storing of location information includes storing the location information and the information representing an event in a database, and the step of transmitting the information including the result of retrieving includes querying the database according to geographic location. The method can be performed such that the step of querying the database according to geographic location further includes restricting the querying to events associated with an organization, e.g., a university, employer, club, etc., with whom the user of the second device is associated, which user receives the transmitted information including the result. The method can be performed such that wherein the result of querying the database according to geographic location returns a plurality of events located within a predetermined distance from a geographic location of the user of the second device, such as a user of a device who receives the transmitted information including the result.

In accordance with a particular aspect of the invention, the geographic location of the user of the second device can be statically defined. In accordance with a particular aspect of the invention, the second device can be a mobile device, such that the geographic location of the user of the second device is subject to change with movement of the mobile device.

The method can be performed such that the step of querying the database according to geographic location can further include receiving text information relating to at least one of the events from at least one of the first devices, and the step of storing the location information further includes storing the text information in the database in association with the received location data, and the step of transmitting the information further includes transmitting the stored text information. In accordance with a particular aspect of the invention, the geographic locations of the users can be geographic locations of the first devices. In accordance with a particular aspect of the invention, at least some of the first devices can be mobile devices.

In accordance with a particular aspect of the invention, the one or more events can be defined prior to the step receiving the data representing respective geographic locations of the users.

In accordance with an aspect of the invention, a method is provided which includes using at least one computer in: a) receiving data from mobile devices associated with users of a social networking service, the data representing respective geographic locations of the users; b) storing location information representative of respective geographic locations of the users, and storing information representing an event and a geographic location of the event; and c) transmitting information to at least one second device for display thereon, the transmitted information including a result of retrieving the location information of users whose geographic locations match the geographic location of the event, together with the geographic location of the at least one event, and a quantity of the users whose geographic locations match the geographic location of the at least one event.

In accordance with an aspect of the invention, data can be received from mobile devices associated with respective users of a social networking service, in which the data may include data representing respective geographic locations of the users. Location information representative of respective geographic locations of the users can be stored using the received data. For example, information can be stored which represents an event and a geographic location of the event. Information can be transmitted to at least one second device, in which the transmitted information may include a result of retrieving the location information of users whose geographic locations match the geographic location of the event. Such transmitted information can be transmitted together with the geographic location of the at least one event. The transmitted information can also include information representative of a quantity of the users whose geographic locations match the geographic location of the at least one event.

In accordance with a particular aspect of the invention, the data can be received from the mobile devices associated with the respective users without requiring the users of the mobile devices to provide input to such mobile devices. The steps in such method can be performed in real time such that the result of querying the database represents the geographic locations of the users in real time.

In accordance with an aspect of the invention, a method is provided which includes using at least one computer in: a) receiving data from first devices associated with users of a social networking service, the data representing intentions of the users to attend a defined event in the future; b) storing information in a database associating the received data with information representing a geographic location of the event; and c) during the event, transmitting information including a result of querying the database for display by at least one second device, the information representing the event, the geographic location of the event, and a quantity of the users whose current geographic locations match the geographic location of the event.

In accordance with an aspect of the invention, method can include using at least one computer in receiving data from first devices associated with users of a social networking service, in which the data may represent intentions of the users to attend a defined event in the future. Information can be stored in a database which associates the received data with information representing a geographic location of the event. During the event, information can be transmitted which includes a result of querying the database for display by at least one second device. Such transmitted information can represent the event, the geographic location of the event, and a quantity of the users whose current geographic locations match the geographic location of the event.

In accordance with an aspect of the invention, a method is provided which includes using a computer in: a) receiving data from first devices associated with users of a social networking service, the data representing respective geographic locations of the users; b) storing location information representative of respective geographic locations of the users and information identifying the users, and storing information representing an event and a geographic location of the event; and c) transmitting information to at least one second device for display thereon, the transmitted information including a result of retrieving the location information of users whose geographic locations match the geographic location of the event, together with the geographic location of the at least one event, and a quantity of the users whose geographic locations match the geographic location of the at least one event, and indicia identifying the users.

In accordance with an aspect of the invention, a method is provided which can include using a computer in: receiving data from first devices associated with users of a social networking service, in which the data can represent respective geographic locations of the users. The method can include storing location information which is representative of respective geographic locations of the users and information identifying the users. Information representing an event and a geographic location of the event can be stored during this step. The method can include transmitting information to at least one second device for display thereon, in which the transmitted information can include a result of retrieving the location information of users whose geographic locations match the geographic location of the event. The result of retrieving the location information can be transmitted together with the geographic location of the at least one event, and a quantity of the users whose geographic locations match the geographic location of the at least one event, and indicia identifying the users.

A method according to an aspect of the invention can include using at least one computer in: a) receiving location data from a first device associated with a user of a social networking service, the location data representing a geographic location of the user; b) storing information in a database associating the received location data with an event in accordance with the geographic location and with information identifying the user; and c) transmitting information including a result of querying the database for display by at least one second device, the information representing the event, the geographic location of the event, and a name of the user.

In accordance with an aspect of the invention, a method can include using at least one computer in: receiving location data from a first device associated with a user of a social networking service, in which the location data representing a geographic location of the user; information can be stored in a database which associates the received location data with an event in accordance with the geographic location and with information identifying the user. Information can be transmitted which includes transmitting information including a result of querying the database for display by at least one second device. The transmitted information which includes the result can include information representing the event and the geographic location of the event, and can include a name of the user.

In accordance with a particular aspect of the invention, the step of receiving the data from the first device can include receiving location data from a plurality of the first devices associated with respective users of the social networking service. The step of transmitting the information including the result can include transmitting a result of retrieving information from the database which represents a quantity of the users whose geographic locations match the geographic location of the event.

In a method according to any of the aspects of the invention described in the foregoing, an event can be a planned gathering of people at a particular location. Alternatively, an event can be an impromptu gathering of people, or a first event can be a planned gathering of people and a second event can be an impromptu gathering of people at a particular location. In general, the “location” identified by the location information represents a physical location in a three-dimensional coordinate space such as a terrestrial location. However, in a particular embodiment, the location identified by the location information represents a virtual location which can be attended by two or more people attending a virtual collaborative work effort, “meeting”, “conference”, webchat, chatroom, etc., in cyberspace in which the participation of the people by one or more of speaking, listening, or presenting or receiving information through the medium of the virtual collaborative work effort or “meeting” can be determined and reported on using one or more of the methods according to the aspects of the invention herein.

A system according to an aspect of the invention can include a computer which is configured to perform a method in accordance with one or more aspects of the invention set forth herein.

A tangible nontransitory computer-readable storage medium according to an aspect of the invention can have a set of instructions recorded thereon which are executable by a computer to perform a method in accordance with one or more aspects of the invention set forth herein.

A tangible nontransitory computer-readable storage medium according to an aspect of the invention can have a set of instructions recorded thereon which are executable by a processor of a mobile device to perform a method which comprises: a) receiving data from mobile devices associated with users of a social networking service, the data representing respective geographic locations of the users; b) storing location information representative of respective geographic locations of the users, and storing information representing an event and a geographic location of the event; and c) transmitting information to at least one second device for display thereon, the transmitted information including a result of retrieving the location information of users whose geographic locations match the geographic location of the event, together with the geographic location of the at least one event, and a quantity of the users whose geographic locations match the geographic location of the at least one event.

A tangible nontransitory computer-readable storage medium according to an aspect of the invention can have a set of instructions recorded thereon which are executable by a processor of a mobile device to perform a method which can include receiving data from mobile devices associated with users of a social networking service, the data representing respective geographic locations of the users. The method can include storing location information representative of respective geographic locations of the users and information representing an event and a geographic location of the event. The method can include transmitting information to at least one second device for display thereon, in which the transmitted information can include a result of retrieving the location information of users whose geographic locations match the geographic location of the event, e.g., by retrieving the location information from a database which stores the location information stored therein based on the data received in the receiving step. The transmitted information can be transmitted together with information retrieved, e.g., from a database, which indicates the geographic location of the at least one event, and the transmitted information can be transmitted together with a quantity of the users whose geographic locations match the geographic location of the at least one event.

A mobile device according to an aspect of the invention can include a processor, and instructions which are executable by the processor to perform a method. The method can comprise, for example: a) receiving data from mobile devices associated with users of a social networking service, the data representing respective geographic locations of the users; b) storing location information representative of respective geographic locations of the users, and storing information representing an event and a geographic location of the event; and c) transmitting information to at least one second device for display thereon, the transmitted information including a result of retrieving the location information of users whose geographic locations match the geographic location of the event, together with the geographic location of the at least one event, and a quantity of the users whose geographic locations match the geographic location of the at least one event.

Alternatively, the instructions can be executable by a processor to perform a method which can include storing location information representative of respective geographic locations of the users and information representing an event and a geographic location of the event. The method can include transmitting information to at least one second device for display thereon, in which the transmitted information can include a result of retrieving the location information of users whose geographic locations match the geographic location of the event, e.g., by retrieving the location information from a database which stores the location information stored therein based on the data received in the receiving step. The transmitted information can be transmitted together with information retrieved, e.g., from a database, which indicates the geographic location of the at least one event, and the transmitted information can be transmitted together with a quantity of the users whose geographic locations match the geographic location of the at least one event.

A method according to an aspect of the invention can include: a) transmitting location data from a mobile device to a server of a social networking service for storage in a database associated with the server, the location data representing a geographic location of the mobile device; b) querying a database associated with the server in accordance with the location data representing the geographic location of the mobile device; and c) receiving information including a result of querying the database for display on the mobile device, the information including the geographic location of at least one event, and a quantity of the users whose geographic locations match the geographic location of the at least one event.

A method according to an aspect of the invention can include transmitting location data from a mobile device to a server of a social networking service for storage in a database associated with the server. The location data can represent a geographic location of the mobile device. The method may include querying a database associated with the server in accordance with the location data representing the geographic location of the mobile device. The method may further include receiving information including a result of querying the database for display on the mobile device. The information received may include, for example, the geographic location of at least one event, and a quantity of the users whose geographic locations match the geographic location of the at least one event.

A system according to an aspect of the invention can be configured for collecting location data from user devices and display that information. Such system can be configured to collect data pertaining to a user's location on a device at a dynamic time interval either determined by the system or by the user; to analyze said data, comprising first determining the density of users on a map, and second determining changes in user density over time; to analyze points of high density on a map, comprising categorizing high and low density points by a list of points of interest collected or generated by the system; and to display said information, such as by an overlay on a map.

A system according to an aspect of the invention can be configured for collecting location data from user devices and display that information. Such system can be configured to collect data pertaining to a user's location on a device at a dynamic time interval either determined by the system or by the user. The system can be configured to analyze the collected data, which can include first determining the density of users on a map, for example, and second determining changes in user density over time. The system can be configured to analyze points of high density on a map, which may include comprising categorizing high and low density points by a list of points of interest collected or generated by the system, for example. The system may be configured to display some aspect of the collected which may be the analyzed or categorized points of high density, low density or both, such as by an overlay on a map.

In accordance with a particular aspect of the invention, the user's location can be determined by one or more location sensors, such as global positioning system data, for example, data from any or all of: one or more wireless networks, one or more cellular networks, a location on the Internet, or a magnetic compass.

In accordance with a particular aspect of the invention, the system can be configured to utilize data generated by user input, e.g., tactile, voice or other input from a user of the device from which the user's location data is received to improve accuracy of the location measurement.

In accordance with a particular aspect of the invention, data generated by the user device and the system can be stored and made accessible to one or more other users, one or more other devices or computers, such as at a central location or on a user device.

In accordance with a particular aspect of the invention, the system can be configured to collect user data concerning at least one of: one or more qualitative parameters of at least one event; and one or more quantitative parameters of at least one event to improve the categorization described above.

In accordance with a particular aspect of the invention, the system can be configured to collect data pertaining to a certain location rather than to a user.

A method according to an aspect of the invention can include measuring and predicting changes in the location and density of users on a map into some time in the future. In accordance with a particular aspect of such method, a determination of the predicted changes can be made by comparing the number of users entering and exiting an area per a unit time. In one example, a determination of the predicted changes can be made by a historical data collected by the system. In one example, a determination of the predicted changes can be made based on user input through the device, including queries for user data. In one example, a determination of the predicted changes can be made through data gathered though the Internet, which may include one or more of: a social media provider, one or more postings, event data regarding one or more events, one or more user updates, one or more calendars, and one or more messages transmitted according to an e-mail protocol, e.g., MIME (Multipurpose Internet Mail Extensions), or SMTP (Simple Mail Transfer Protocol), among others.

A method according to an aspect of the invention can include distributing data collected and generated through an application, such as may include predicted current and future locations of a single user, for example. In one example, the data may include predicted current and future changes in density of users over a map. In one example, the data may include ratings data based on a set of user input. In one example, the data can be broadcast over social media sites. In one example, the data can be broadcast as notifications through a mobile device, e-mail, instant messaging clients, and other Internet messaging services. In one example, the data can be stored, organized, and retrieved at a later time in the future on an online repository, either on the mobile device or at a central location. In one example, the data can be accessed by a third party through an application programming interface (API). In one example, the activity of users in a specific region can be organized and distributed through a sorted list, chart, or via any graphical and textual means.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating a system in accordance with an embodiment of the invention;

FIG. 2 is a diagram further illustrating a system in accordance with an embodiment of the invention;

FIG. 3 is a diagram illustrating operation in accordance with an embodiment of the invention;

FIG. 3A is a diagram illustrating operation in accordance with an embodiment of the invention;

FIG. 4 is a diagram illustrating information which can be stored during operation in accordance with an embodiment of the invention;

FIG. 5 is a diagram illustrating information which can be displayed during operation in accordance with an embodiment of the invention;

FIG. 6 is a diagram illustrating information which can be displayed during operation in accordance with an embodiment of the invention;

FIG. 7 depicts an input screen for collecting information from a user in accordance with an embodiment of the invention;

FIG. 8 depicts an input screen for collecting information from a user in accordance with an embodiment of the invention;

FIG. 9 is a diagram illustrating operation in accordance with an embodiment of the invention;

FIG. 10 is a diagram depicting information which can be displayed during operation in accordance with an embodiment of the invention; and

FIG. 11 is a diagram depicting information which can be displayed during operation in accordance with an embodiment of the invention.

### DETAILED DESCRIPTION

In accordance with one or more embodiments of the invention, a system and related method for providing data and collecting and analyze data from location aware mobile devices on a network. Additional features and advantages are realized through techniques described herein.

In accordance with one or more of the present embodiments, data relating to a user's geographic location can be utilized in novel ways to provide services which were not possible heretofore. In an embodiment herein, one or more networks can collect and distribute location data concerning individuals, e.g., users of mobile devices who can be registered users of a social networking service. Location data associated with a particular user can be transmitted to a social networking website by a mobile device, such as a cellular telephone or multi-function mobile device commonly referred to as a “smartphone”. The location data can represent a geographic location of the mobile device user, such as determined, for example, by triangulation performed in the cellular telephone network, or by a global positioning system (“GPS”) sensor within the mobile device.

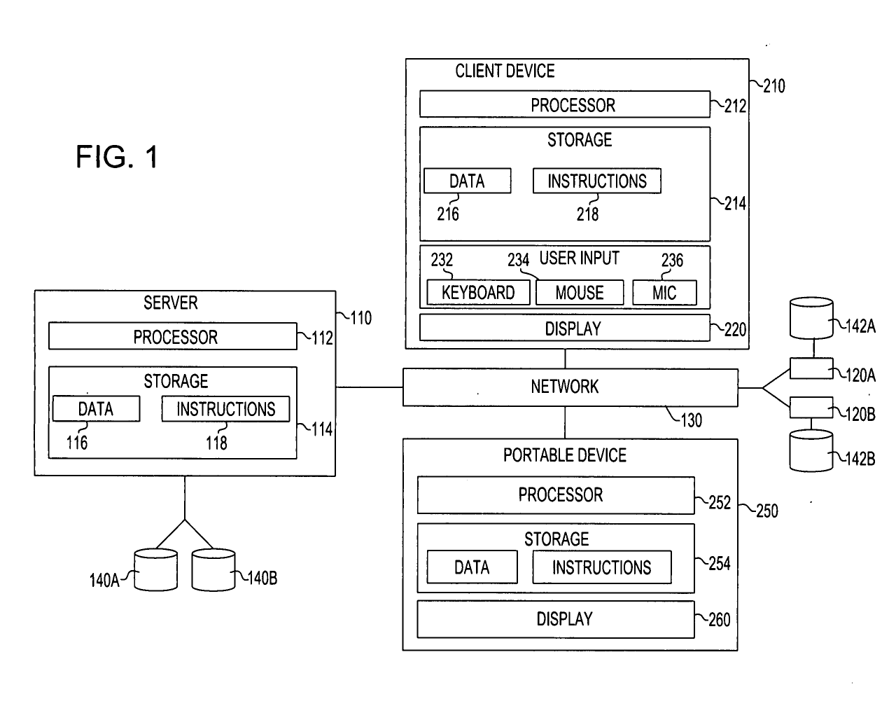

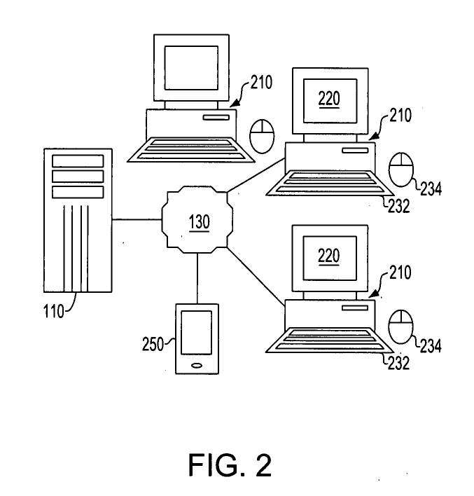

As shown in FIGS. 1 and 2, an event organization, management and publicity system can include a computer or information processing system 110, for example, a computer having a processor 112 that may include one or more microprocessors. The computer 110 may function as a server to serve data and instructions to other computers. Storage 114 is available for storing and retrieving information used by the processor. For example, storage 114 may be used to store data 116 and instructions 118 which are executable by the processor. Storage can include, for example, one or more of various magnetic, solid-state or optical drives, etc., for read-write access to data and instructions. The storage can also include one or more various portable memory media which can be read-write type, read-only type or combination type (e.g., a type of medium designed to be written only once but read many times), which can be recorded or read by electrical, magnetic, or optical means. For example, the storage can include an internal or external memory drive or miniature memory card, e.g., SD card or drive, a compact disc (“CD”) or CD-ROM, digital versatile disc (“DVD”), magnetic tape media, etc., which are easily and readily interchangeable with other similar media, and on which data or instructions or both can be recorded, read and, in some cases, executed by computer 110. The server 110 can be connected to additional storage 140A, 140B, which can be locally connected thereto. The additional storage can house one or more repositories of data, e.g., sources of test data such as one or more databases which track orders of tests and the results which are produced by the tests.

The instructions 118 can be any instructions which are executable by the processor, such as machine language instructions, or can be in any computer language such as source code which is compiled in advance of execution or interpretable code which is interpreted during execution. The data can be handled, i.e., written to storage or retrieved therefrom or modified based on the execution of the instructions 118 by the processor. Although the storage 114 is shown together with processor 114 in computer 110, the storage may or may not be housed together with the processor in the same physical unit.

In one example, networking equipment 130 (hereinafter, “network”) can be used to facilitate communication between the computer 110 and a plurality of auxiliary servers 120A, 120B, to which additional databases can be accessed in storage 142A, 14B. The network can also connect the server with one or more client devices 210, as seen in FIG. 2. The client devices typically include a processor and memory and typically have the ability to communicate with devices or computers external thereto. The client devices can be general purpose computers, e.g., microcomputers such as desktop computers, laptop computers, or can have more specialized function such as can be provided as tablet computers, or mobile computing devices which may or may not incorporate a cellular telephone function and which support the execution of at least some types of software. Examples of client devices include IPad and IPhone and other tablet computers and smartphones such as Blackberry and Android-enabled devices. The three client devices 210 shown in FIG. 2 are merely illustrative, as there can be fewer or more client devices capable of connecting to a server 110 or to each other through a network 130. The network 130 can include one or more types of networks, such as, but not limited to: an enterprise network for the primary use or control by a particular organization, an intranet, i.e., a non-public network operating in accordance with the communication protocol known as Internet Protocol, or can be another type of a private or virtual private network, etc. The network 130 can include portions extending within a public network such as the Internet. In such case, provisions can be made for secure connections through the Internet to satisfy security and quality-of-service goals. Communications between nodes can be facilitated by any of a variety of network communication protocols, such as, without limitation, wired or wireless communication protocols.

Like computer 110, client devices 210 typically include a processor 212 (FIG. 1) and are capable of storing and retrieving data 216 and instructions 218 from associated storage 214 which may be housed together with the processor or separately therefrom. The client device typically includes a display 220, e.g., a screen capable of electronically displaying still or moving images or both, which is capable of displaying information to a user in a form readable or recognizable by the user. Devices such as a keyboard 232 and a mouse 234, trackball or other pointing device typically are provided for registering user input. The display, keyboard, mouse (or both) can together facilitate inputting of user information through a graphical user interface (“GUI”) such as a Windows® operating system-enabled display (Windows is a registered trademark of Microsoft Corporation). For example, user input may be of a type which causes the display of information presented to the user at a particular location on the screen to be modified when the user selects the location using a mouse or other pointing device.

As specifically shown in FIGS. 1-2, a particular kind of client device can be a mobile device 250 such as a smartphone such as an IPhone®, Android-enabled device, Blackberry device, or other handheld computer such as a personal digital assistant, e.g., or cellular phone type device, which may have a wireless interface or a wired (contact-based) interface may also be provided which can connect with computer 110 or other client device 210 through network 130. Like computer 110, the mobile device 250 can have a display 260 for presenting information to the user and typically has one or more of a keyboard (not shown) or keypad (not shown) and pointing device (not shown) for registering user input therewith. Like computer 110, mobile device 250 has a processor 252 and storage 254 for the storage of instructions for execution by processor 252 to retrieve, store or modify data. Although some functions may be indicated below as being performed on a server and other functions may be indicated as being performed on a client device, various aspects of a system and method may be implemented by a single computer. In a typical arrangement, many of the client devices can be mobile devices 250.

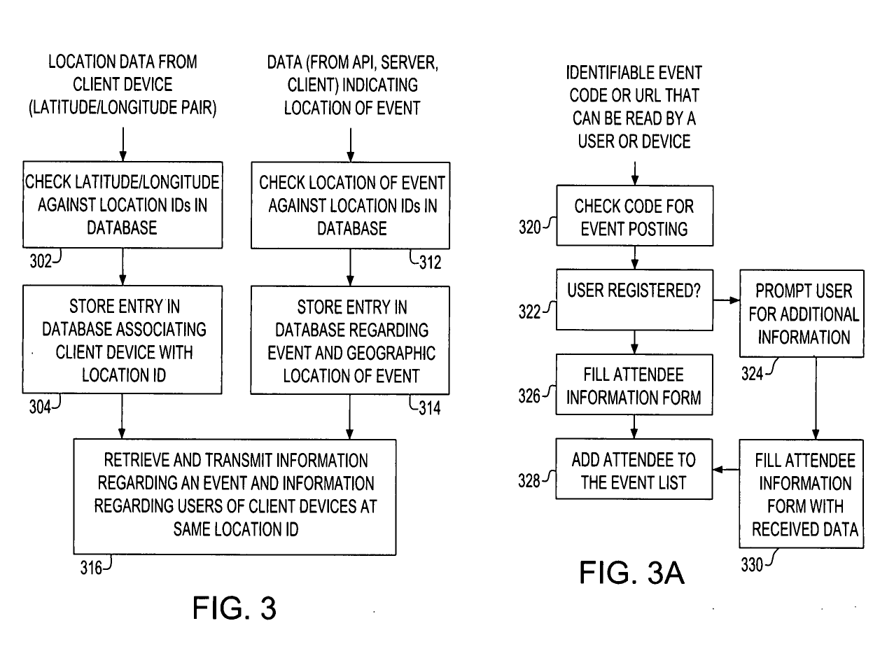

FIG. 3 is a flow chart illustrating operation in accordance with an embodiment of the invention. As depicted in FIG. 3, at 302 location data is received from a client device at a server. The location data can include a latitude/longitude pair identifying the geographic location of the client device, such as can be provided through triangulation in a wireless (e.g., cellular) network, or via a GPS receiver in the client device. At 304, the received location data (e.g., latitude/longitude pair) can be checked against that of a location identifier (“location ID”) already stored in a database of the server. If a location ID already exists, an entry is stored in a database of the server which associates the client device with the existing location ID. If no location ID exists yet, in one embodiment, the server can transmit (not shown) a signal to the client device to prompt the user of the client device to identify the location, such as by street address, apartment number, etc., to permit a location ID to be created therefor. The location ID can associate a latitude/longitude pair or range of latitude and longitude with a particular street address or other location name which is commonly understood. Later, when information about a particular client device or an event is transmitted to another device, the information can include the street address or location name to help the user of the other device to understand the identified location easily.

Events can be added to a database via operations such as those shown at 312 and 314. As shown at 312, data is received at a server which indicates a location of an event, such as a gathering of people, e.g., either a planned or impromptu gathering of people such as a party, lecture, concert, etc. The database which stores the event information can be the same database or a different database from that which stores information regarding the geographic locations of client devices. In particular embodiments, event data can be received from an application programming interface of a service, e.g., another social networking service, or can be received from a server or a client device in the network. The client device can be stationary, e.g., a laptop or desktop computer, or can be a mobile device, as described above. At 312, the server can then check the received data concerning the event location against location IDs already stored in the database. If there is a match, at 314, a server can then store an entry in the database regarding the event and a geographic location of the event. If the data received regarding the event location does not match an existing location ID, the server can create a location ID after obtaining further information from the source of the received data, for example. An event typically has limited duration, such that the entry may store a date and a time for the event or a range of dates or a range of time or times for the event. Recurrence can be noted as well, such that the database stores one or more entries that represent recurrences of an earlier event. The entry may list details about the event such as an event name, a sponsor or organizer, whether the event is public or private, any restrictions on admittance to the event, any differential pricing offered to attendees.

With information now stored about events and the locations of client devices in one or more databases, a second device, e.g., another client device can obtain information regarding what events in the user's vicinity are currently happening or about to happen, and can obtain information regarding the quantity of other people who are attending the event. For example, in step 316, a server can retrieve and transmit information regarding an event happening in the user's vicinity, as well as information indicating the number of client device users whose geographic locations match the geographic location of the event. In one example, the server can also obtain information from a database regarding the location IDs of the users and the location ID of an event to determine how many users there are whose location IDs match the location ID of a particular event. The server can then transmit such information via the network to another device, e.g., stationary or mobile device of a user. The server can transmit this information immediately in response to a query generated by the user, or the server can transmit this information at another time, such as on a predetermined schedule, or the server can transmit this information as a message or notification pushed to the user, e.g., for promoting the event, such as when the user has authorized such notifications, or when the user has enabled an “intelligent agent” to obtain or provide such notifications.

FIG. 3A illustrates a particular arrangement in which information regarding event attendance of users of a social networking service can be gathered. In this arrangement, a user carrying a client device (e.g., a mobile device) who arrives at an event can use the client device to scan a predefined machine-readable symbol, or characters, or can input a particular uniform resource indicator (“URI”) to the client device, and the client device will then link to an online address associated with such symbol, characters or URI. In a particular embodiment, the machine-readable symbol can be a “Quick Response” (QR) symbol, for example. For example, a mobile device which scans the QR code typically will wirelessly link to site at an online address represented by the QR code. At 320, a server receiving a communication after the client device scans the QR code can check to determine whether there is an existing entry in the database that corresponds to the event. When the check at block 320 succeeds, at block 322 it is determined whether the user of the client device is currently registered with the social networking service for which an entry exists regarding the event. This check can be done using information identifying the client device, such as an Internet Protocol (“IP”) address of the mobile device, or other user identification such as an existing “userid” which can be transmitted by the client device when it links to the online address represented by the QR code. Information regarding the user obtained from the social networking service can then be used to populate an information form regarding the user's attendance at the event, as seen at 326. In one embodiment, at 328, the attendee information can then be added to information stored on a computer as a record of the event and the attendees thereof as an “event list”.

However, when the user has not previously registered with the social networking service, at 324 the server can transmit a signal to the client device which prompts the user for additional information about the user. The user can then input the requested information, and at 328 the information inputted by the user can then be used to populate an information form regarding the user's attendance at the event, as seen at 326. Again, at 328, the information used on such attendee form can be added to information stored on a computer as a record of the event and the attendees thereof as an “event list”.

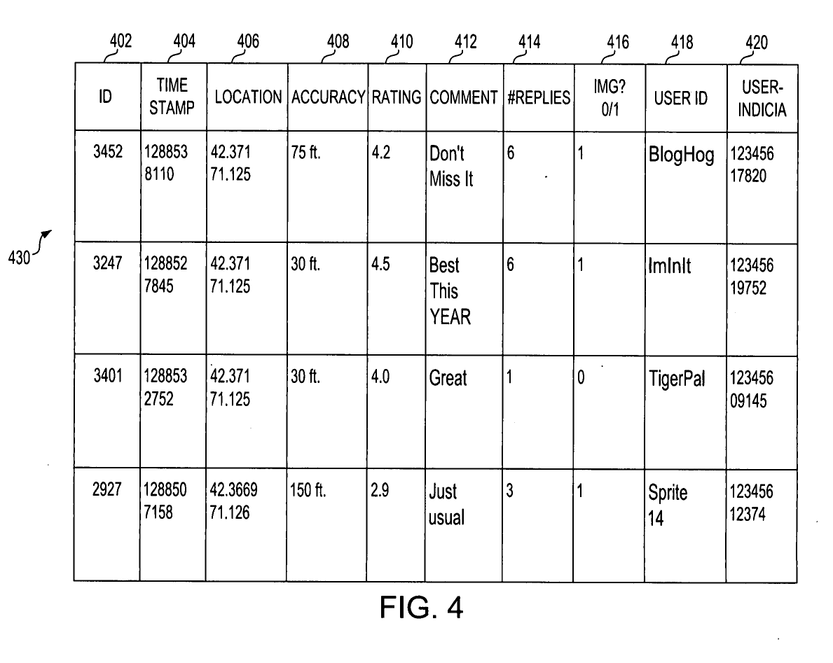

As indicated above, information received from client devices regarding events and users' attendance thereat can be stored in one or more databases. FIG. 4 illustrates a particular example in which a database contains a plurality of records generated from users' attendance at various events at different locations within a general vicinity of each other. Each row of data shown in FIG. 4 represents a record of a particular user concerning a particular event. Although each record is shown as a single integral record, it may be possible to store a record as multiple records which are linked together. Each column represents a particular type of data stored in the record.

Column 402 contains a record identifier or “ID”. The ID can be automatically generated when storing a new record to the database. Column 404 contains a Timestamp indicating a time at which the client device posts information to the social networking service about the user's attendance or about the event. In one example, such as seen in FIG. 4, the Timestamp can have a commonly used format such as “Time in seconds since 12:00 a.m. Jan. 1, 1970.” Column 406 provides a “Location” of the client device. The “Location” can be provided as a latitude/longitude pair, and can correspond to that of a predefined Location at which an event is already known by the social networking service to be taking place. Otherwise, the “Location” can be latitude/longitude coordinates of the client device at the time the client device posts information to the social networking service. In one example, column 408 provides an “Accuracy” estimate regarding an accuracy in distance of the “Location” recorded in column 406. The estimated accuracy can be higher or lower depending upon the particular technique used to determine a latitude/longitude pair (e.g., wireless triangulation or GPS) and elapse time between the last determination of the client device's location and the time at which the client device posts to the social networking service. The information in these columns 402, 404, 406, 408 are collected in each record and are expected to be maintained in persistent records.

By contrast, in some implementations not all of the information corresponding to the remaining columns may be collected or maintained persistently. Column 410 stores a rating provided by the user when posting about an event. The rating can be a global rating for the event or can represent an averaged rating concerning several categories. Column 412 stores a comment by the user about the event, such as “Don't Miss It” as indicated in the comment for the record in the first row 430 of FIG. 4. Column 414 records a number of replies to the particular post recorded in the first row of FIG. 4. Column 416 records whether or not the post contains an image. If the post contains an image, a link is made to the image so that the image can be retrieved when information regarding the event including the corresponding post is retrieved and transmitted to another user of the social networking service.

Column 418 can record a userID of the user whose post is recorded in that row of the database. Column 420 can record user indicia identifying the user, such as an IP address or other information.

As seen in FIG. 4, the records corresponding to the rows shown in FIG. 4 are made by users having different userIDs. The first three records in the top three rows of FIG. 4 may relate to the same event, since the latitude/longitude pairs in the Location column are all the same. Therefore, when information regarding an event at that location is retrieved from the database (such as in response to a query from a stationary or mobile device) information from each of these three records may be retrieved. However, the information in the fourth record (bottom row of FIG. 4) may not be retrieved when the user requests information about the event to which the first three records relates.

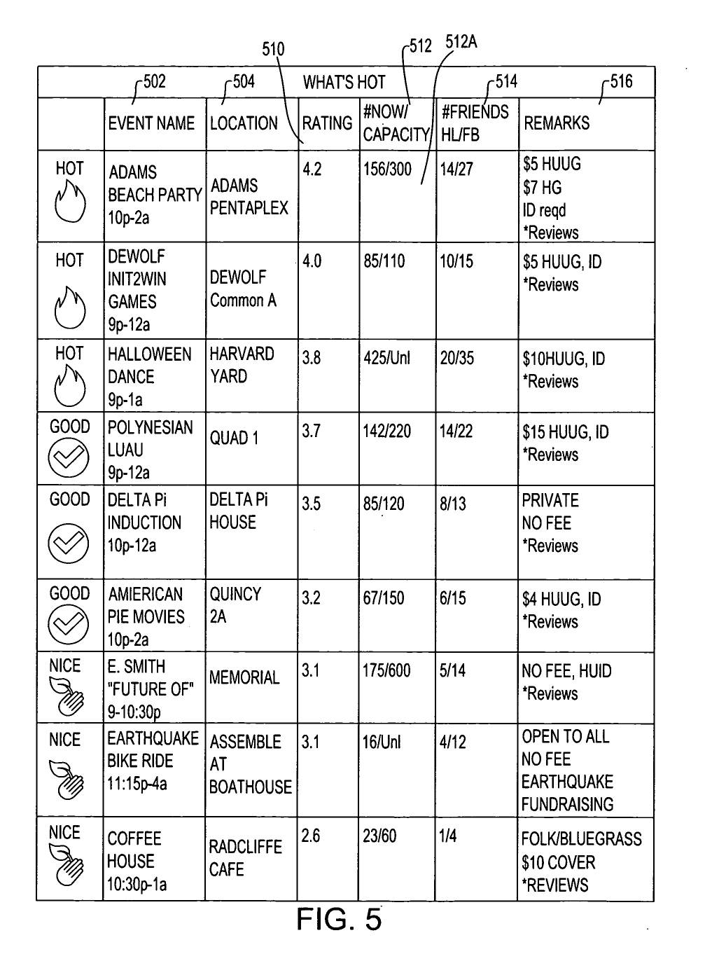

FIG. 5 illustrates an example of information which can be provided to a user of the social networking service regarding events which are occurring on a particular date and time, for example, Halloween evening at Harvard University in Cambridge, Mass. FIG. 5 further illustrates a particular example in which the information can be displayed to the user. As mentioned above (FIG. 3), the information can be provided by retrieving information from one or more databases, the one or more databases storing information regarding events and location data of users.

As seen in FIG. 5, the displayed information can be ranked according to ratings 510, each of which may represent an aggregation of ratings provided by a plurality of users who are attending or have attended the event. The ratings enable the generation of a “What's Hot” list of events which can help to convey to others what are the most popular events in the vicinity at a particular time. The most popular events may be marked with an icon (e.g., a fire symbol) and a designation such as “HOT”. Other events which can be popular but maybe not quite as much, and may not have received as high of ratings, can be marked with a different icon (e.g., a check mark) and a designation such as “GOOD”. Still other events might not be as popular but may still be worthy of interest, and can be marked with a different icon, such as an outstretched hand and be marked “NICE”.

The information can further include an “Event Name” 502 and a commonly understood “Location” 504, which can be a name of the location or a street address or building and internal unit address, such as “Quincy 2A”, for example. This information can be retrieved from an event database which stores information about previously defined events such as parties or other gatherings of people, for example. The displayed information can further include information 512 indicating an actual or estimated number of people currently attending the event, and may also include information about the capacity of people at that event. For example, an entry 512A in the column “156/300” indicates there are currently 156 people at the event and that the event has a capacity of 300 people. Column 516 indicates further details about each event such as an admission price, and the terms of admission. For example, the column can indicate different prices for different attendees, e.g., undergraduate versus graduate students, whether or not undergraduates or graduates are welcome, and whether or not student identification is required. Column 516 may further contain an icon, symbol or a word such as “*Reviews” which the user can activate to view what another user has written about the particular event, such as the other user may have written in a post, as described above (FIG. 4).

The displayed information may further include information 514 indicating a number of friends of the client device user who are currently attending the event. Stated another way, the information displayed to a particular user on that user's client device can indicate how many of that user's friends are at the event. The information can include numbers of users of different social networking services who are recorded as “friends” of that particular user by the different social networking services. For example, in the first row of FIG. 5 relating to the “Adams Beach Party” the information 514 indicates that the particular user has 14 “friends” who are registered with the HL social networking service, and 27 “friends” who are registered with the FB social networking service. This information is available and can be gathered for transmission to the client device of respective users because the location data representing the geographic locations of users at various times can be obtained by the operation of the client devices, as indicated above. Users of the social networking service can be requested to grant permission to the social networking service to collect the location data before any location data is collected. In one example, the permission can be limited to a particular geographic area, such that location data will be collected when the particular user is within the particular area, and will not be collected when the particular user travels outside the particular area. In another example, the user can grant permission just for limited times on a particular date, such as by granting permission for location data to be collected for the next 6 hours on Halloween evening, after which the permission will expire, and collection will stop.

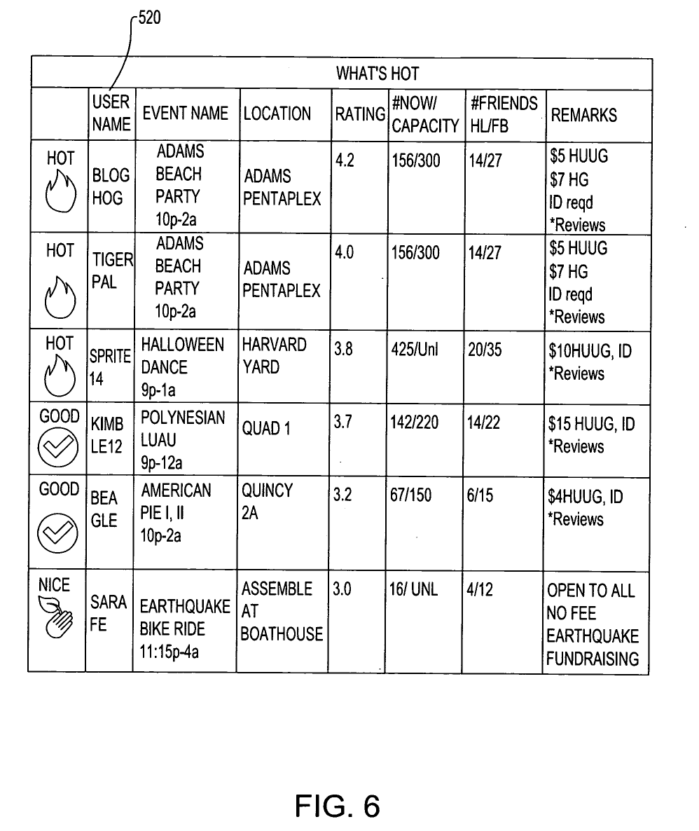

FIG. 6 illustrates a particular embodiment of information which can be retrieved and displayed to a particular user, such as on a client device (mobile or stationary), such as in response to a request by that user. Here, the particular user has several “pals”, who are other users of the same social networking service with whom the user may be closely associated. For example, the other users can be pals because the user often attends events, e.g., parties with the pals. In this case, the displayed information can be sorted by or restricted to events attended by that user's pals. As seen in column 520, the displayed information now indicates the user names of that user's pals in one or more rows regarding events occurring at the time.

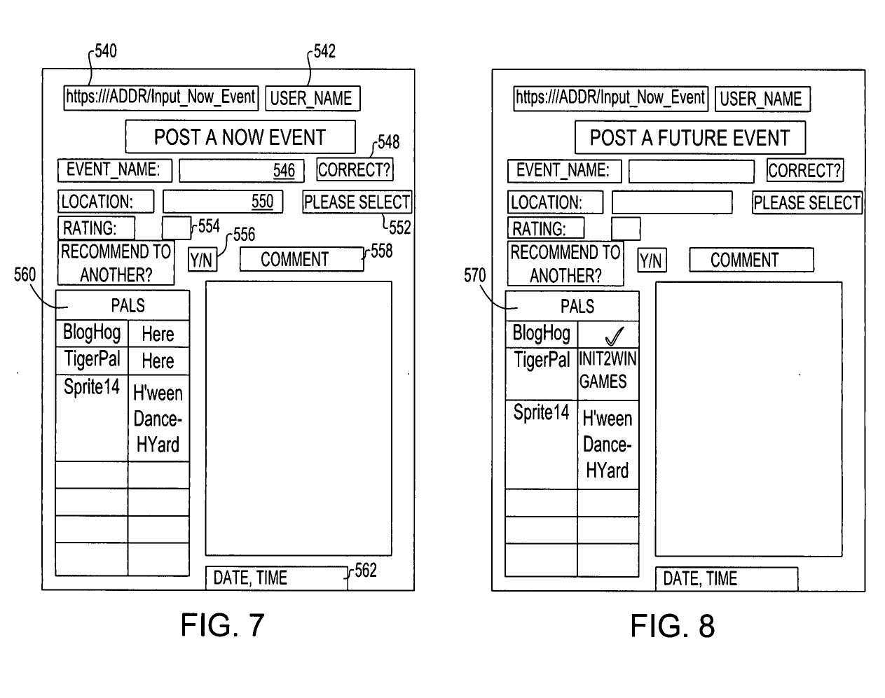

FIG. 7 illustrates an example of an input screen “POST A NOW EVENT” that a user can use to create a post concerning an event occurring at that particular time. The screen may display the current URI 540 in a space provided therefor and the screen may display the user name 542 of the particular user who is currently logged in to the social networking service on the particular client device. The screen contains an input box 546 for the user to input a name of the event EVENT_NAME to which the user's post relates. In one example, the user may input a part of the event name and the display may provide one or more choices the user can select from, such as in a drop-down list. In one example, the user can signify that the inputted event name is correct by activating a button 548 therefor. The user can do the same when inputting information regarding a location of the event through an input box 550 provided therefor, and a “Please Select” function 552. The user can further provide a rating in an input box 554 therefor. In one example, the input box can accept a star rating in which the user selects a rating for the event from one to five stars which can be displayed in the input box 554.

The user can be further prompted to indicate whether or not the user would recommend the event to another, such as by selection input at 556. Input box 558 provides space for the user to input a comment about the event. In one example, a table 560 can be displayed which lists the locations of the user's pals. In this case, the table indicates that pal “BlogHog” and pal “TigerPal” are both at the event about which the user is preparing to post, but that another pal “Sprite14” is at a different event. Finally, as seen at 562, the displayed information can include an indication of the current date and time.

FIG. 8 illustrates a variation of the input screen shown in FIG. 7 which can be used to post information about a future event. The user is given an opportunity to provide information such as that shown in FIG. 7 based on the user's expectations about how the event may turn out. For example, the user may want to post a rating or a comment relating to a similar event that occurred in the past. FIG. 8 varies from FIG. 7 in that table 570 now indicates the events that the user's pals expect to attend at the time the particular event is planned. In this case, the pal BlogHog expects to attend the same event about which the user is preparing to post. However, the other pals TigerPal and Sprite14 have indicated they expect to attend different events. Although not shown, this input screen can further include an input box to permit the particular user to indicate whether he expects to attend the particular event.

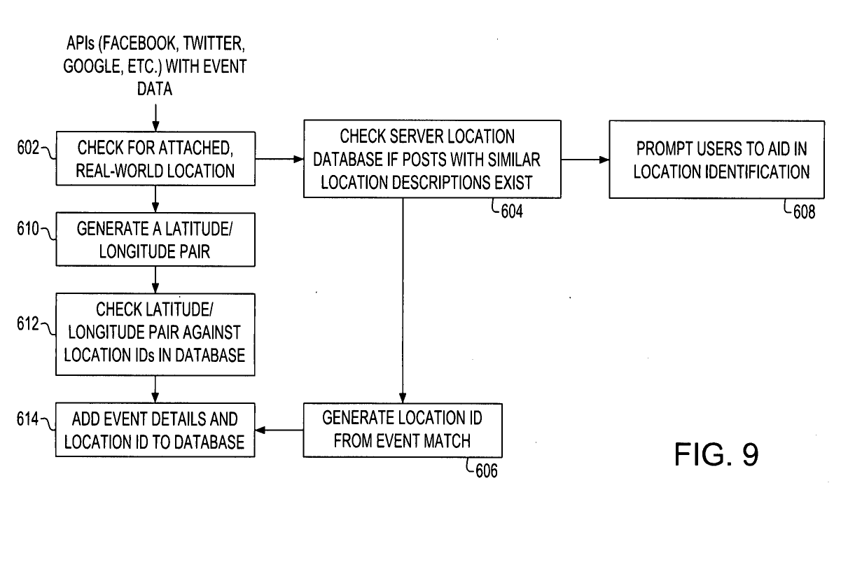

FIG. 9 illustrates one way that events can be registered with the social networking service to enable further operation, e.g., receiving of information regarding events and user attendance thereat, as described in the foregoing. As seen in FIG. 9, event data can be received from a variety of sources, such as through application programming interfaces (“APIs”) of various services, e.g., Facebook, Twitter, Google, etc., and then checked (602) as whether the data regarding an event indicates a real world location. If it does not, a server location database can be checked (604) to determine whether previously entered data, such as data entered previously via posts from users, contains a similar location description and a location ID. If a similar location description is found, then the location ID corresponding to the similar location description can be selected. However, if the server location database does not contain a similar location description, one or more users of the social networking service can be prompted to aid in the location identification, at 608.

Otherwise, when the check for a real world location succeeds (602), then a latitude/longitude pair can be generated for the location (610). At 612, the latitude/longitude pair may be further checked to find a corresponding location ID in a database. When such check is successful, the location ID and details about the event can be added to a database therefor (614), such as an event database.

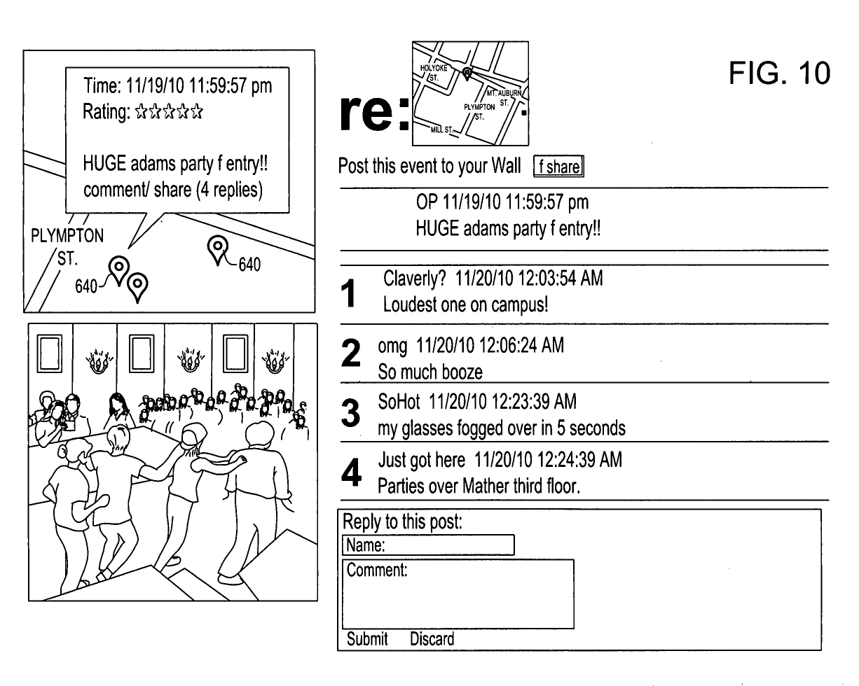

FIG. 10 further illustrates an example of information which can be displayed to a user concerning an event. FIG. 10 contains an image such as a photograph taken at a particular event, a map displaying an approximate location of the event relative to streets in Cambridge, Mass., as well as a list of users' posts about the event (the posts containing the comment “HUGE adams party f entry!!” or being numbered 1, 2, 3 and 4). FIG. 10 further illustrates an input box usable by a user to submit a “Reply to this post.”

Additional information regarding particular embodiments or particular ways of implementing various functionality in accordance therewith is provided as follows. Object oriented software can be used in or without association to relational data basis to enable speed of processing. For example, information about a particular entry or in a memory file can be stored in form of object oriented algorithms and organized in relational databases for ease of recovery.

A system in accordance with an embodiment of the invention can emphasize a location oriented approach rather than a user oriented approach to location-based services. To this end, information about specific client devices as used by one or more users having different locational components, for example such as at different locations on a map, can be collected and stored or dynamically displayed selectively to one or more client devices. In one embodiment, this can provide the benefit of being used by one or more users of a social networking service in that the system's functionality is emphasized on providing a location oriented rather than user oriented approach to location-based services. Instead of displaying only information about specific nodes or users at different locations on a map, the system can collect and display information about the number of users at a location, which need not be tied to a user specifically.

A system in accordance with one embodiment can include a manager located at any location in the system. The manager can assess information, such as location-based information and can then recognize and analyze points of interest based on a variety of factors from users access and/or input, or through other collection methods, such as locational components as provided by the nodes. In this way, one or more points of interest can be established. A point of interest can for example by defined as location of a gathering, of a particular group size (i.e. large group), or in a specific location, such as locations that offer specific services to users such as a place of business, or any other location that might be of emergent value to a user. In a particular embodiment, the system manager finds a variety of points of interest through a counter or other counting algorithms and provides/reporting the number of users reported at a certain location selectively to one or more users, one or more nodes or other points along the system. This allows the system to by remain highly dynamic, in that points of interest can emerge instantaneously and be provided to the user, and need not be stored in a database beforehand, except if intended such as to provide historical data. In this way, for example, a group of users can either converge or avoid a particular place, such as parties or amusement park rides, on a real time basis.

In another embodiment, the system 100 can be used to determine points of interest by aggregating data collected through use of one or more applications accessible by nodes such as through social media sites, such as in the form of status updates from a specific user, online calendars, event postings, and the like. By identifying recurring words or references in the data collected, for instance, around a certain event at a given location or a permanent location over time, the system manager can identify points of interest through by their popularity and display them on a map. Furthermore, points of interest can be reported by a single user or a number of users, for instance, in the event that a user has prior knowledge that such a point already exists or would exist in the future. In addition, by searching through information collected at an earlier time, the system can identify additional points of interest through trends in the data around a certain location or user submissions (i.e. ratings). Finally, in a similar manner, points of interest stored at an earlier time to the system can be removed if the system determines through a number of methods that there is little or no evidence to show interest in a predetermined location, using the methods listed above.

Through the use of collected data about a given set of points of interest, a user's location can be more accurately determined on the network. Location data can be detected using any of a variety of means, such as information from any or all of the following: global positioning system (herein GPS), a wired or wireless network, a cellular network, Internet location services, or a magnetic compass, among others. When such location data is combined with data collected through the system, the number of possible locations that a user would likely be located can be reduced significantly. If an ambiguity about a user's location still persists, the system will query the user for additional input about their location from a list of all possible locations, either in the form of a prompt or a message sent to the user's device. In addition, even when there is no ambiguity, the system will confirm the user's location periodically through the same method to increase the accuracy of its predictions while also helping strengthen the prediction system.

The quality of various points of interest can also be assessed through quantitative and qualitative queries to a user device. These queries can include a rating system whereby certain desired qualities can be judged on a numeric scale (such as from 1 to 5 or 1 to 10), through check boxes that the user can select from which list certain available services and amenities, or by a series of questions whereby a user can reply back to the system in plain text using their own input or by choosing from a list of preselected choices. In a particular embodiment, a user can be asked to provide information (i.e. polled at various times), but more specifically when a user enters or exits the vicinity of a point of interest, when the user shares their location with other users, or when a user submits a point of interest to the system.

Additionally, in one embodiment, the system manager can be selectively designed to only query users within a predefined geographical or socio-professional boundary, including a specific town, city, campus, student group, professional group, social group, and the like. Therefore, each boundary can be assigned its own points of interest within its bounds which will be available for users currently residing within them. A user can additionally enter and exit different boundaries at any time, as determined by the system through a user's location. Points of interest outside the user's bounds will not be affected in this embodiment.

Furthermore, data can be collected from users about their location at a flexible rather than predetermined rate. This provides many advantages over traditional systems, including lower bandwidth consumed by the service over the network and lower power use consumed by a mobile device to access the system. Such approach may allow the system to achieve higher accuracy while making measurements, since it can allow the system to discover more information from users and areas when there is an ambiguity or when accuracy of the data is a concern.

In one example, as seen in FIG. 10, locations 640 of points of interest, e.g., events can be identified on a map by means of an identifier (i.e. a mark). As discussed before, the change in location over time can also be stored for later referral or use. For example, different bottle necks in traffic at a particular road can be avoided by this type of historical data for a month, a year or a given day each day or month (such roads to be avoided on a particular holiday at a particular time). In one embodiment, a user interface method (i.e. a slider bar) can be used to move through time (back and forth) for example to provide historical information (i.e. parties in the past weekends) or even moved into the future to provide speculative data about future events based on calculation of prior events or selectively as provided by directed user input of particular scheduled events.

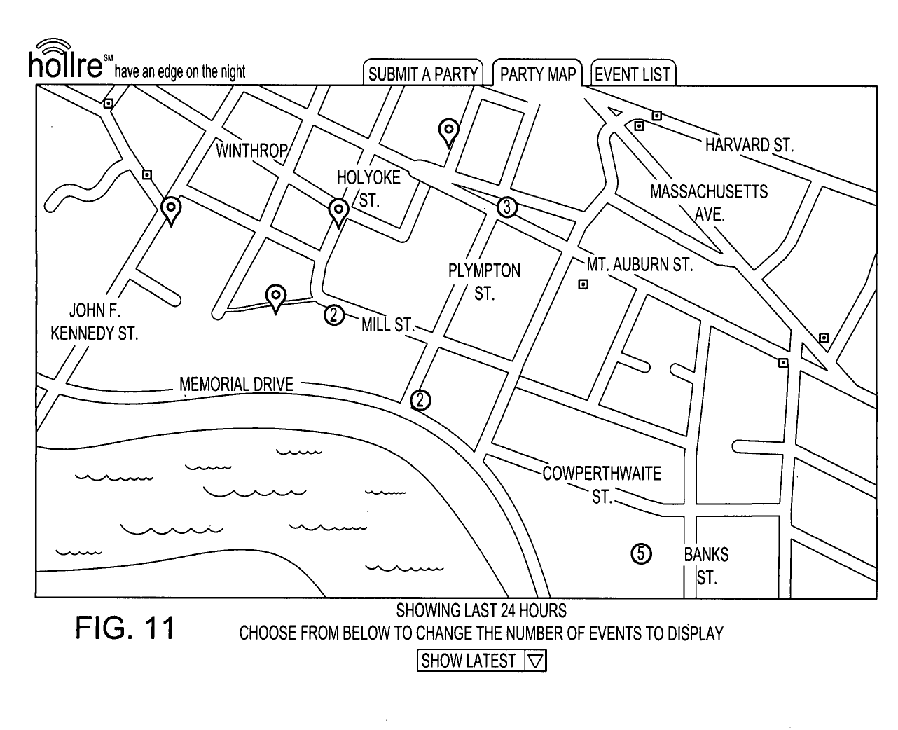

In addition, particular points of interest can be selected, such as by a click of a mouse, so as to provide more detailed or specific information. In the example shown in FIG. 10, this may include clicking on buildings for specific information about a party. The map, no matter what platform they are obtained from (Google maps in this example) can then be stored selectively in a memory location (internal, external server location etc.) somewhere in the system. Other maps can also be then incorporated in the larger maps to provide more detail information. For example, in the example of FIG. 11, a particular university map (i.e. Harvard) is integrated into a larger map (Google map) for ease of use selective to a user or a node. The system can also be used across platforms so that these integrated maps can easily be crossed over into other maps on other platforms (i.e. android map in this example). The system can also provide other functions as appreciated by those skilled in the art. For example, the users or any node can use the system to enable individual account check-ins on private accounts or across the World Wide Web in general. The system manager can also be used to authenticate users to a special site or even a social network site (such as Facebook).

In addition, one or more users can provide a rating system that can be kept private or distributed throughout the system for one or more location or other selective criteria. In a similar way, the system manager can not only provide location sensing to direct and or to obtain information from a user node but can also provide users/nodes means to allow postings to a particular feed (e.g. party feed through Facebook, twitter etc.) by simply rolling or clicking a button etc. at a presented user page (i.e. rolling on right/left side of the page.)

A system in accordance with an embodiment of the invention can operate on a variety of different platforms. For example the mobile browser style, provided in one embodiment can have different feels for different devices. Such system may also include one or more device interfaces, as necessary to port to a number of platforms, including but not limited to androids, iPhones, blackberries, palms, window and other operating systems or other devices.

While the invention has been described in accordance with certain preferred embodiments thereof, those skilled in the art will understand the many modifications and enhancements which can be made thereto without departing from the true scope and spirit of the invention, which is limited only by the claims appended below.

What is claimed is:

1. A method, comprising:
using at least one computer in:
a) receiving data from first devices associated with users of a social networking service, the data representing respective geographic locations of the users;
b) based on the received data, storing location information representative of the respective geographic locations of the users;
c) storing information representing an event and a geographic location of the event; and
d) transmitting information to at least one second device, the transmitted information including a result of retrieving the stored location information of users whose geographic locations match the geographic location of the event, together with the geographic location of the at least one event, and a quantity of the users whose geographic locations match the geographic location of the at least one event.

2. A method, comprising:
using at least one computer in:
a) receiving location data from first devices associated with users of a social networking service, the location data representing respective geographic locations of the users;
b) storing information in a database associating the received location data with one or more events in accordance with the respective geographic locations; and
c) transmitting information including a result of querying the database for display by at least one second device, the information representing at least one of the events, the geographic location of the at least one event, and a quantity of the users whose geographic locations match the geographic location of the at least one event.
